(19) United States
(12) Patent Application Publication
(10) Pub. No.: US 2023/0363549 A1
(43) Pub. Date: Nov. 16, 2023

(54) Channel Mattress

(71) Applicant: Thomas A. Turowski, Valrico, FL (US)

(72) Inventor: Thomas A. Turowski, Valrico, FL (US)

(21) Appl. No.: 17/738,125

(22) Filed: May 6, 2022

(51) Int. Cl. A47C 27/14; A61G 7/057

(52) U.S. Cl. CPC A47C 27/146; A61G 7/05723

(57) ABSTRACT

The invention relates to a convertible mattress that can be used for regular and/or medical purposes with a channel which facilitates a person's shoulder and/or arm to allow a person to sleep comfortably with reduced pain or minimal pain. The size and shape of the mattress can be such that it fits any type of bed including, but not limited to full, twin, queen or king size bed. The mattress can also have the channel of the invention on each side, opposite ends which facilitates rotating or flipping the mattress, right side or left side or at the head or foot of the mattress.

### CROSS-REFERENCE TO RELATED APPLICATIONS

This application claims the benefit of U.S. Provisional Patent Application No. 63/184,939, filed on May 6, 2021, which is incorporated by reference herein in its entirety.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

Trademarks used in the disclosure of the invention and the applicants make no claim to any trademarks referenced.

### BACKGROUND OF THE INVENTION

### 1) Field of the Invention

The invention relates to the field of mattresses and sleeping surfaces.

### 2) Description of Related Art

Currently the state of the art includes mattresses that have large flat, generally uniform surfaces. When an individual sleeps on his or her side on one of these conventional mattresses, the person's body parts either displaces the mattress's material or the individual's shoulder becomes compressed under the body or becomes bent forward or backward. The mattress opposing reaction to the individual's body creates pressure points on the individual that corresponds to those body parts that protrude the deepest into the mattress. Moreover, when sleeping on one's side, a person's backbone becomes laterally curved. The result is that the individual can be very uncomfortable and the various positions can cause serious pain that can result in damage to joints and nerves.

Therefore, it is obvious that conventional mattresses do not provide pressure relief for an individual suffering from shoulder and arm pain because conventional mattresses provide a flat surface that applies pressure on the body to support the body on the mattress. This pressure can result in pain when an individual who has a condition such as a dislocated shoulder or a problem with their arm is exacerbated by the contact with the mattress. Conventional mattresses can also result in compressed arms and discomfort in the shoulder or rib area.

Therefore, what is needed in the art is a mattress which allows an individual to obtain relief from the pressure points caused by the mattress's reaction to the person's body.

In particular, there is a need for a solution to at least one of the aforementioned problems. For instance, there is a need for a mattress that minimizes pressure points caused by a conventional mattress opposing reaction to a person's body.

### BRIEF SUMMARY OF THE INVENTION

Conventional mattresses do not provide a relief mechanism to remove the pressure from a mattress for an individual's arm or shoulder when that individual sleeps on their side (i.e., side sleeper). The issue is further compounded when a mattress is used by one or more individuals who may or may not need a relief mechanism, such as when a mattress is shared by two individuals with one of them needing relief and the other does not.

The instant invention is applicable to home use or use in a hospital, caregiving institution, hotel environment or any other location in which a mattress may be used.

The instant invention in one form is directed to a mattress that has at least one removable portion to form a cavity in the mattress. The at least one removable portion, also referred to as a filler in this application, provides a relief in the mattress when removed, so that when an individual sleeps on their side the person's body parts that coincides with the removable portion needing relief do not interact with the mattress when the filler is removed and therefore does not displace the mattress material. This prevents the individual's shoulder or other body part from becoming compressed by the resistive force of the mattress material. The removable portion is implemented such that when removed from the mattress, it creates a channel or groove in the mattress which will accommodate a person's body part in order to take the pressure of the mattress off of the body part when that person lays on their side. By eliminating the contact between the mattress and the person's body part, the mattress counteracting pressure is eliminated, and the person's body part is not subjected to pressure, and the person does not feel increased discomfort from laying on the mattress.

Conventional mattresses do not provide pressure relief for an individual suffering from shoulder, arm, knee or hip pain because the conventional mattresses provide a flat surface that applies pressure on the body to support the body on the mattress. This pressure can result in pain when an individual uses the mattress who has a condition with their shoulder, arm or other body part which is in contact with the mattress.

An advantage of the present invention is that a person using the mattress of the instant invention is subjected to less pain than if they used a traditional flat mattress which applies pressure to the person's body.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 is a solid mattress of the instant invention;

FIG. 2 shows a person sleeping on the instant invention;

FIG. 3 is an exploded view and an assembled view of a multipiece mattress of the instant invention;

FIG. 4 is an exploded view and an assembled view of a multipiece mattress of FIG. 3 with a channel filler piece;

FIG. 5 is an exploded view and an assembled view of a multipiece mattress with a trapezoidal channel;

FIG. 6 is an exploded view and an assembled view of a multipiece mattress;

FIG. 7 shows an alternative mattress of the instant invention where the channel filler is comprised of a bottom channel filler piece and top channel filler piece;

FIG. 8 shows an alternative mattress of the instant invention where the mattress is formed from the head piece, lower mattress, middle mattress and a support;

FIG. 9 shows an alternative embodiment of the instant invention having a channel that runs parallel to the length of the mattress;

FIG. 10 shows an alternative embodiment of the instant invention that has a first channel that runs parallel to the length of the mattress and a second channel that runs perpendicular to the first channel;

FIG. 11 shows an alternative embodiment of the mattress of the instant invention where the mattress is formed from head support member, lower mattress which is formed from multiple mattress pieces and a support;

FIG. 12 shows an alternative embodiment of the mattress of the instant invention where the mattress is formed from head support member, a support, a lower mattress which is formed from multiple mattress pieces and an outer support; and

FIG. 13 shows a fitted sheet of the instant invention.

Corresponding reference characters indicate corresponding parts throughout the several views. The exemplifications set out herein, illustrate embodiments of the invention and such exemplifications are not to be construed as limiting the scope of the invention in any manner.

### DETAILED DESCRIPTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however, that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure be considered as an example of the principles of the invention and not intended to limit the invention to the specific embodiments shown and described.

The terms mattress, bed, cushion, pallet, futon, support, spring, box spring and innerspring, are used interchangeably to mean a support which is designed to support a person laying down. The mattress can have a length and a width and the length is designed such that a person lays on the mattress such that their head is proximal to the top of the mattress and their feet are proximal to the end of the mattress which is distal from the top of the mattress.

The terms foam, memory foam, gel foam, pillow tops, innerspring, waterbed, hybrid, air bed, latex foam, adjustable bases and are used interchangeably to mean the material used to fabricate a support which is designed to support a person laying down.

The term innerspring is meant to mean an innerspring component which is part of an innerspring mattress that is constructed with interlocking spring coils.

The term memory foam is meant to mean a mattress that is made from soft comforting foam that supports and cradles your body to respond to pressure points of a person laying down.

The term hybrid is meant to mean a mattress that includes both foam and innerspring technology.

The term foam mattress is meant to mean a mattress made of foam and includes any suitable foam such as but not limited to polyurethane foam, memory foam, gel memory foam, open cell memory foam, gel foam, reflex foam, convoluted foam, evlon foam, and latex rubber foam.

The term air bed as a mattress, is made with a non-permeable material to contain air and provide support to a person laying down on the air mattress. The mattress can be made from one or many chambers.

The term waterbed as a mattress, is made with a non-permeable material to contain water and provide support to a person laying down on the water mattress. The mattress can be made from one or many chambers.

The term person, individual, patient, customer and client are used interchangeably to mean an individual using the instant invention.

The instant invention forms at least a two-tier sleeping surface comprised of flat sections of the mattress which form the flat sleeping surface and pockets, cavities or channels which form the stress reliving sections of the mattress.

In one or more aspects of the present disclosure, the instant invention can be used by individuals who have sustained an injury to their shoulders, neck, knees or hips; the instant invention can also be used by individuals who prefer to sleep on their side or individuals requiring minimizing of pressure on specific body parts. The instant invention is envisioned to help the over 70% of the world population who are side sleepers, many of whom have related sleep disturbances and health problems; the instant invention provides a channel or cavity in the mattress to accommodate a body part and therefore minimizes the pressure applied to the body part from mattress displacement. The channel allows for the individual to sleep on their side without undue pressure on the shoulder, neck, upper torso, knees or hips. By providing this design feature to a traditional sleeping surface, the mattress of the instant invention has demonstrated extensive health benefits that include relief from knee, hip, shoulder, neck, back nerve impingement, and improved arterial flow.

The mattress of the instant invention can be used on any bed type, such as but not limited to, a gurney, cot, bunk bed, full size bed, twin size bed, queen size bed or king size bed.

The mattress of the instant invention can be formed from a variety of materials such as foam, memory foam, gel foam, innerspring, waterbed, air mattress, latex foam and innerspring construction.

The prior art does not provide for a system that is configurable to limit pressure from a mattress in select body locations by providing removable sections of the mattress that allow a person or individual to remove a section of the mattress so that a body part of the person is not in contact with the mattress and therefore is not subjected to the reaction force at that body part location.

According to the National Institute of Health (NIH), 4.851 million people in the United States suffer from shoulder injuries each year and up to 67% of the population suffer neck pain. These individuals suffer a variety of problems including loss of sleep and permanent disabilities due to their injuries. However, with the proper accommodations these individuals could overcome their injuries, and one significant aspect of this recovery would be reducing the pain associated with sleeping on a conventional mattress, due to the mattress applying pressure to the injured body part.

The instant invention in an alternate embodiment is a convertible mattress that can be used for regular and/or medical purposes to allow a person to sleep comfortably with reduced pain or minimal to no pain. The size and shape of the mattress can be such that it fits any type of bed including but not limited to full, twin, queen, or king size bed. The mattress can also have the channel of the invention on each side, opposite ends which facilitates rotating or flipping the mattress, right side or left side or at the head or foot of the mattress.

The mattress of the instant invention can be made from foam, memory foam, gel foam, pillow tops, innerspring, waterbed, hybrid, air bed, latex foam and the material can be selected from any suitable material including but not limited to fabric, plastic, metal, foam, polymer films and polymer impregnated cloth. The base for the bed can be either fixed or adjustable.

Furthermore, the instant invention is a convertible mattress comprising of a lower mattress, a head support member, a base and when the lower mattress and the head support member are placed on the base, that they form a channel and the channel being operably able to receive the shoulder or body part of a person when the person is laying on the convertible mattress.

The instant invention has at least one channel that can have an optional filler. The filler can be designed to fit the entire channel depth or it can be configured so that two or more channel fillers can fit into the channel so that an individual could remove the top channel filler and leave the channel filler below the top channel filler. The filler can also be configured to fill only half the width of the mattress to accommodate a second individual using the mattress and not needing the relief provided by the channel. This allows the individual to selectively provide relief and support for the body part that corresponds with the channel in the mattress.

The instant invention also anticipates the use of a specialized fitted sheet that can be used with the various components of the mattress. The specialized fitted sheets can be constructed to provide material that can extend or forms a pocket that can fit into the channel and still provides a channel for the individual's corresponding body part.

The fitted sheet can also comprise of multiple sheets which encases the sections of the mattress which form the flat sleeping surface of the mattress.

The instant invention can also be used in a variety of situations and environments such as private homes, apartments, hospitals, nursing homes, assisted living homes, rehab centers, military hospitals, schools and any other home or institutional setting.

The mattress of the instant invention could have as many channels as needed to provide a system of channels and support surfaces to meet a customer's needs for their patient or for an individual's needs.

The first embodiment of the mattress of the instant invention is formed from mattress components which create a sleeping surface having at least one channel in the mattress to accommodate a person's body part. The mattress comprises of:
a. a lower mattress forming a lower mattress sleeping surface;
b. a head support member forming a head piece sleeping surface;
c. at least one channel filler removably enabled to form a channel filler sleeping surface and when the at least one channel filler is removed then a channel is created in the mattress to accommodate a person's body part.
d. a mattress support enabled to support said lower mattress, said head support member and said at least one channel filler.

The mattress of the instant invention lower mattress sleeping surface has at least one lower mattress segment which forms a lower mattress sleeping surface and the at least one lower mattress segment being removably enabled to form at least one cavity.

The mattress of the instant invention where the mattress support is formed from an upper mattress support and a lower mattress support.

The mattress of the instant invention wherein the mattress support is attached to the lower mattress and head support member with an attachment device and the attachment device is selected from the group consisting of Velcro, clips, adhesive, adhesive strip and straps.

The mattress of the instant invention wherein the lower mattress sleeping surface has at least one lower mattress segment and an outer support which forms the lower mattress sleeping surface and the at least one lower mattress segment is removably enabled to form at least one cavity in the lower mattress sleeping surface when the one lower mattress segment is removed and the outer support holds the at least one lower mattress segment within the outer support.

The mattress and fillers of the instant invention can be made from either one piece or multiple pieces of mattress material and when made from one piece of mattress material the filler portions can be cut from the mattress material by means of laser cutting, die cutting, hot knife cutting, saw cutting, abrasive cutting, water jet cutting or plasma cutting. When the mattress and fillers of the instant invention are made from one piece of mattress material the manufacturing process minimizes material lost.

Alternatively, the mattress of the instant invention could be formed from a single piece of mattress material such as a piece of foam and the channel would be molded as part of that single piece of mattress material.

A first alternate embodiment of the mattress of the instant invention wherein the mattress is formed from mattress components which create a sleeping surface having at least one cavity in the mattress to accommodate a person's body part comprising:
a. a lower mattress forming a lower mattress sleeping surface comprising of at least one lower mattress segment that is removably enabled to fit within an outer support and the at least one lower mattress segment when removed from the outer support forms a lower mattress segment cavity in the lower mattress sleeping surface and the lower mattress segment cavity is capable of receiving a body part of a person;
b. a head support member forming a head piece sleeping surface;
c. at least one channel filler removably enabled to be received in a channel and the at least one channel filler form sleeping surface when installed in the channel.
d. a mattress support enabled to support the lower mattress, the head support member and the at least one channel filler.

The first alternate embodiment of the mattress of the instant invention wherein the mattress support is formed from an upper mattress support and a lower mattress support.

The first alternate embodiment of the mattress of the instant invention wherein the mattress support is attached to the at least one lower mattress segment and head piece with an attachment device and the attachment device is selected from the group consisting of Velcro, clips, adhesive, adhesive strip and straps.

A second alternate embodiment of the mattress of the instant invention is formed from mattress components which create a sleeping surface having at least one channel in the mattress to accommodate a person's body part comprising:
a. a lower mattress forming a lower mattress sleeping surface;
b. a head support member forming a head piece sleeping surface;
c. a mattress support enabled to support the lower mattress and the head support member and the at least one channel filler.

The second alternate embodiment of the mattress of the instant invention wherein the mattress support is formed from an upper mattress support and a lower mattress support.

The second alternate embodiment of the mattress of the instant invention wherein the mattress support is attached to the lower mattress and head piece with an attachment device and the attachment device is selected from the group consisting of Velcro, clips, adhesive, adhesive strip and straps.

A third alternate embodiment of the mattress of the instant invention comprising a single piece mattress having a lower mattress sleeping surface, head piece sleeping surface and at least one channel in the mattress to accommodate a person's body part.

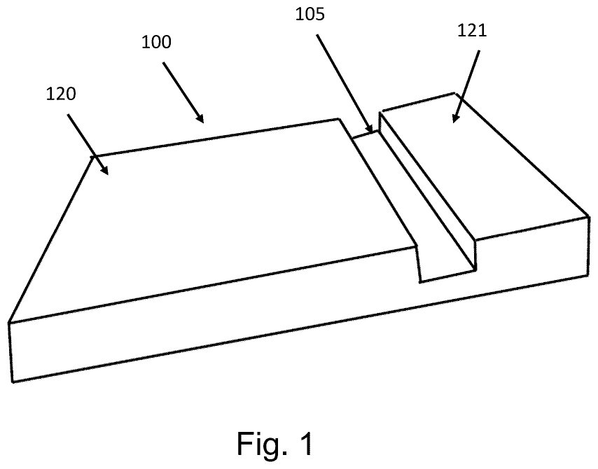

Referring now to the drawings, and more particularly to FIG. 1, there is shown a one piece mattress 100 with channel 105. The mattress has lower sleeping surface 120 and upper sleeping surface 121. The channel 105 can be located at any position with respect to the length of the mattress, and the only requirement is that the channel 105 aligns with a body part of a person seeking to limit the mattress reactive force on the body part.

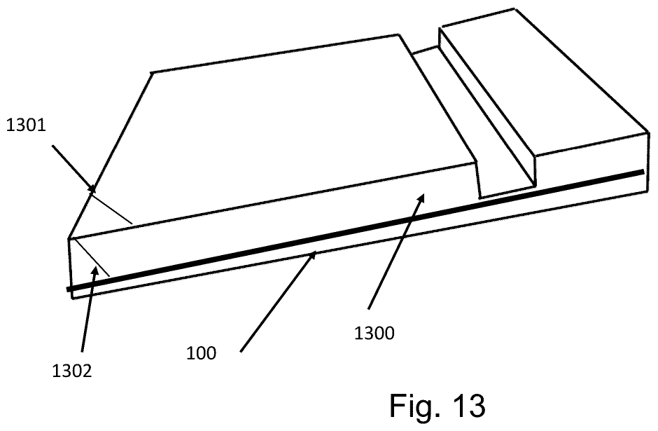

The instant invention also anticipates a single fitted sheet 1300 as shown in FIG. 13 used to cover the mattress 100 shown in FIG. 1 of the instant invention. Fitted sheet 1300 has corner seams 1301 and 1302.

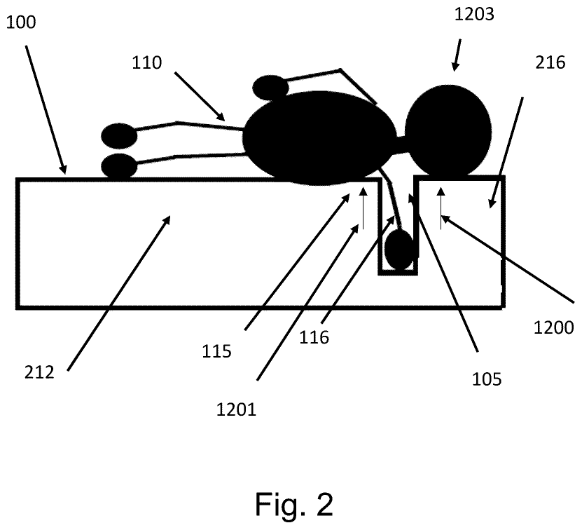

Referring to FIG. 2 which shows a person 110 having shoulder 115 and arm 116 sleeping on the instant invention 100 with head support member 216 and lower mattress 212. The shoulder 115 and arm 116 are in channel 105 such that the person 110 is not experiencing pressure from either the head support member 216 and lower mattress 212 when they are laying on head support member 216 and lower mattress 212. The person 110 is supported by head support member 216 and lower mattress 212 which exerts a reaction 1200 and 1201 that supports the shoulder 115 and head 1203.

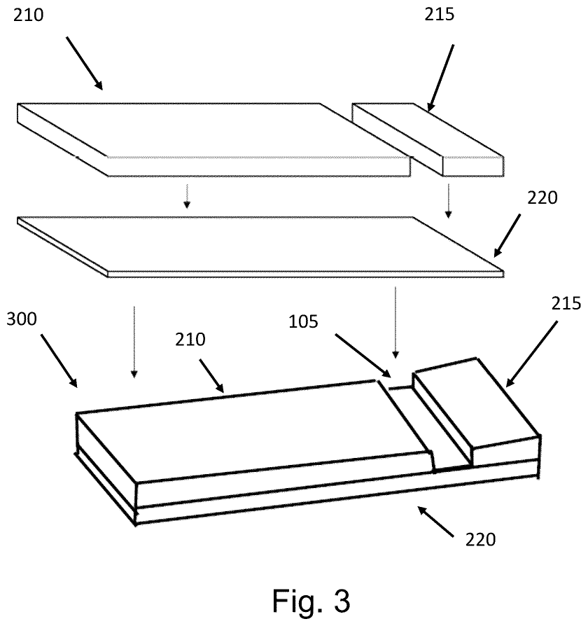

Referring to FIG. 3 which shows an alternative mattress of the instant invention where the mattress 300 is formed from head support member 215, lower mattress 210 and support 220. The space between head support member 215 and lower mattress 210 forms channel 105. The instant invention also anticipates a multi piece bed sheet system where the multi piece bed sheet system has separate pieces used to cover each section of the mattress.

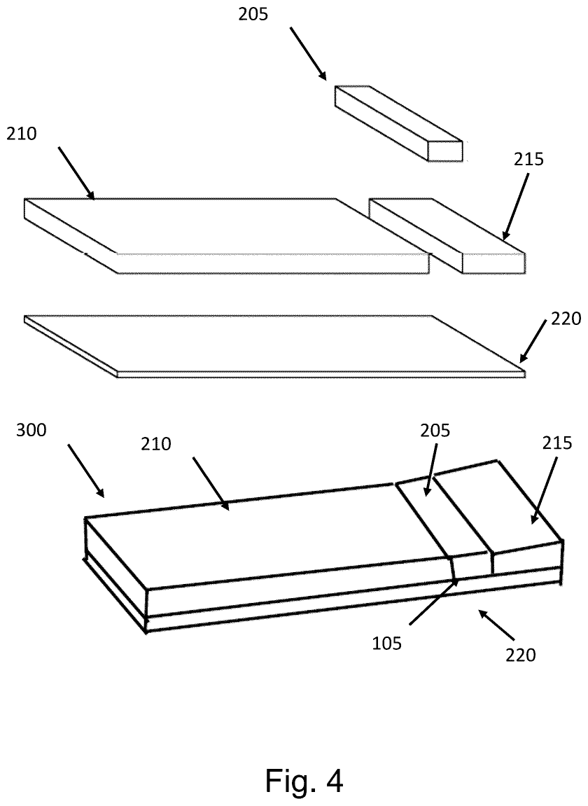

Referring to FIG. 4 which shows an alternative mattress of the instant invention where the channel filler 205 is rectangular and is removably installed so that the channel 105 can be filled and a person who sleeps on their back can comfortably use the mattress without the channel 105. The embodiment mattress 300 is formed from the channel filler 205, head support member 215, lower mattress 210 and support 220. The space between head support member 215 and lower mattress 210 forms channel 105 which can removably receive channel filler 205. The instant invention also anticipates a multi piece bed sheet system where the multi piece bed sheet system has separate pieces used to cover each section of the mattress. Alternatively, a special fitted sheet or sheets can be fabricated to hold all parts of the mattress 300, head piece 215 and lower mattress 210. Additionally, a special fitted sheet can accommodate channel filler 205. The instant invention also envisions an embodiment where support 220 is formed from more than one piece

The instant invention also anticipates a multi piece bed sheet system where the multi piece bed sheet system has separate pieces used to cover each section of the mattress.

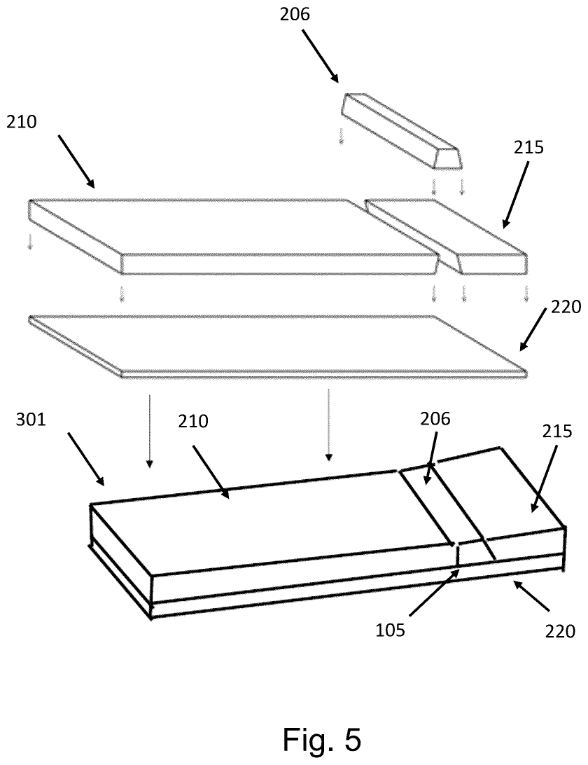

Referring to FIG. 5 which shows an alternative mattress of the instant invention where the channel filler piece 206 is trapezoidal and it can be removably installed so that the channel 105 is filled by channel filler piece 206 and a person who sleeps on their back can comfortably use the mattress without the channel 105. The channel filler piece 205 may also be configured to fill only half the width of channel 105 when a mattress is used by two individuals with different needs of support. The mattress 301 is formed from channel filler 206, head support member 215, lower mattress 210 and support 220. The space between head support member 215 and lower mattress 210 forms channel 105 which can removably receive channel filler 206. The use of a channel filler 206 that is trapezoidal in shape helps lock the channel filler 206 securely between the head support member 215 and lower mattress 210. However, the channel filler 205 can be any shape that is suitable such as a square, a rectangle, a triangle or a circle. The instant invention also anticipates a multi piece bed sheet system where the multi piece bed sheet system has separate pieces used to cover each section of the mattress.

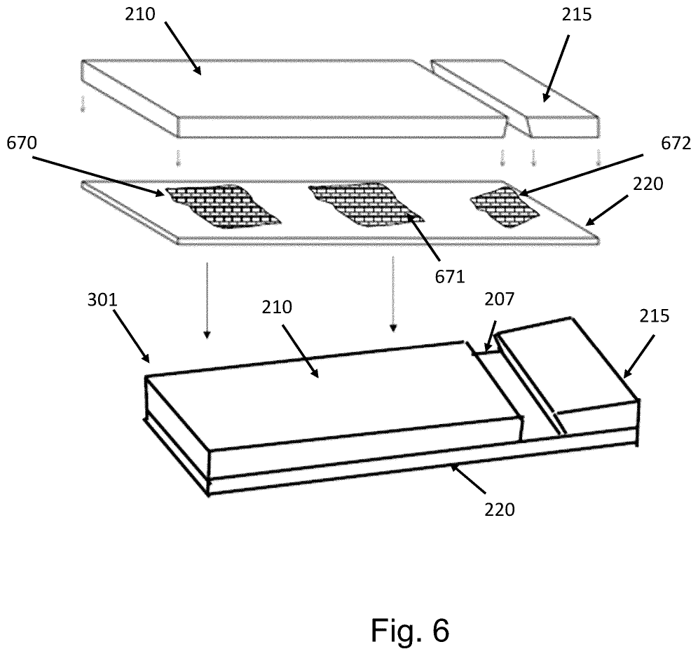

Referring to FIG. 6 which shows an alternative mattress of the instant invention shown in FIG. 5 without the trapezoidal channel filler 206. The mattress 301 is formed from the head piece 215, lower mattress 210 and support 220. The space between head piece 215 and lower mattress 210 forms channel 105. The lower mattress 210 can be attached to the support 220 with attachment devices 670 and 671 and the head piece 215 can be attached to support 220 with an attachment device 672. Attachment devices 670, 671 and 672 can be selected from Velcro, clips, adhesive, adhesive strips, straps or other attachment methods. Alternatively, a special fitted sheet or sheets can be fabricated to hold all the parts of mattress 301 head piece 215, lower mattress 210 and support 220. Additionally, a special fitted sheet can accommodate channel filler 205. The instant invention also envisions an embodiment where support 220 is formed from more than one piece. In one of these alternative embodiments the support 220 could be two layers where there is a bottom and a top layer that forms support 220.

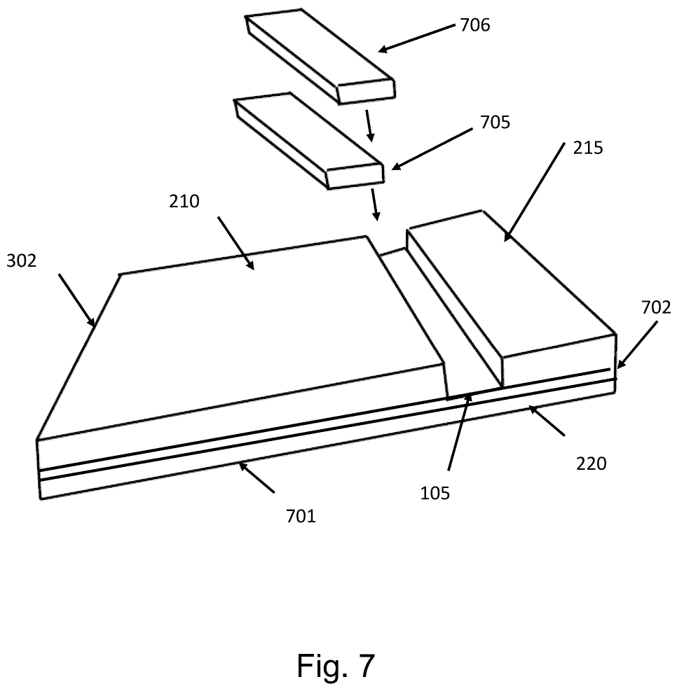

Referring to FIG. 7 which shows an alternative mattress of the instant invention where the channel filler is comprised of a bottom channel filler piece 705 and top channel filler piece 706 and it can be removably installed so that the channel 105 is partially filled which allows the individual to have relief to the affected body part and also provide it support. When bottom channel filler piece 705 is installed without top channel filler piece 706 a person can sleep so that their body is supported by head support member 215, lower mattress 210 and bottom channel filler piece 705 therefore minimizing the stress on their body part while providing some support. In this embodiment mattress 302 is formed from bottom channel filler piece 705, top channel filler piece 706, head support member 215, lower mattress 210 and support 220. The space between head support member 215 and lower mattress 210 forms channel 105 which can removably receive channel filler 705 and 706. In one of these alternative embodiments the support 220 could be two layers where there is a bottom 701 and a top layer that forms support 702.

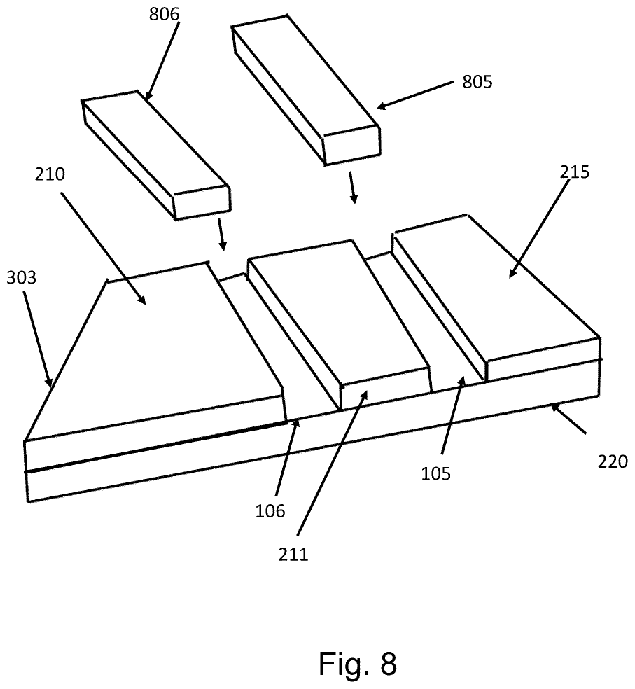

Referring to FIG. 8 which shows an alternative mattress of the instant invention. The mattress 303 is formed from the head piece 215, lower mattress 210, middle mattress 211 and support 220. The space between head piece 215 and middle mattress 211 forms channel 105 which is designed to accommodate channel filler 805. The space between middle mattress 211 and lower mattress 210 forms channel 106 which is designed to accommodate channel filler 806. Head piece 215 and lower mattress 210 can be attached to support 220 with attachment devices similar to 670, 671 and 672 shown in FIG. 6 and the attachment devices can be selected from Velcro, clips, adhesive, adhesive strips, straps or other attachment methods. A person needing relieve from pressure exerted by the mattress can remove the channel filler 806 which would expose channel 106 or remove the channel filler 805 which would expose channel 105 to provide the needed relief from the pressure of the mattress on a corresponding body part. The mattress of the instant invention could have as many channels as needed to provide a system of channels and support surfaces to meet a customer's needs for their patient or for an individual's needs. The instant invention also anticipates a multi piece bed sheet system where the multi piece bed sheet system has separate pieces used to cover each section of the mattress. Alternatively, a special fitted sheet or sheets can be fabricated to hold all the parts of mattress 303, head piece 215, support 220, lower mattress 210 and support 220 and middle mattress 211. Additional special fitted sheets can accommodate channel filler 805 channel filler 806.

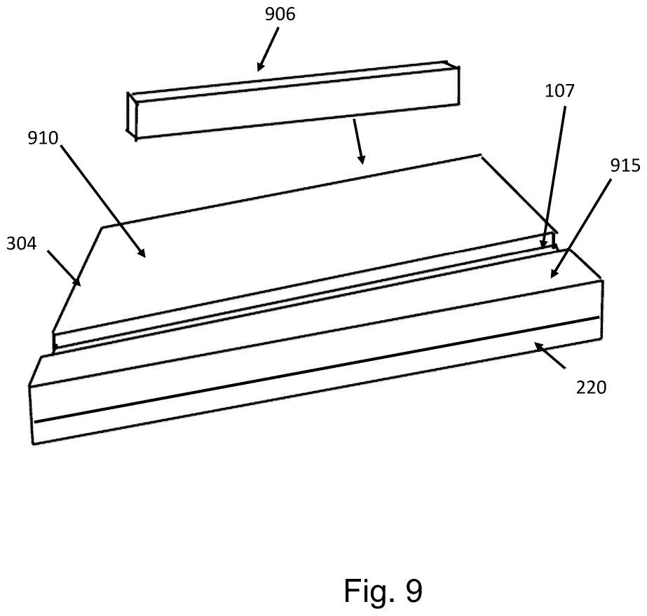

Referring to FIG. 9 which shows an alternative embodiment of the instant invention that has a channel 107 that runs parallel to the length of the mattress. This embodiment has the channel filler 906 which is removably installed so that the channel 107 can be filled and a person who sleeps on their back can comfortably use the mattress without the channel filler 906. Alternatively, a person needing relief from pressure exerted by the mattress can remove the channel filler 906 which would expose channel 107. The mattress 304 is formed from the channel filler 906, right mattress 915, left mattress 910 and support 220. The space between right mattress 915 and left mattress 910 forms channel 107 which can removably receive channel filler 906. The right mattress 915, left mattress 910 can be attached to support 220 with attachment devices similar to 670, 671 and 672 shown in FIG. 6 and the attachment devices can be selected from Velcro, clips, adhesive, adhesive strips, straps or other attachment methods. The instant invention also anticipates a single fitted sheet or a multi piece bed sheet system where the multi piece bed sheet system has separate pieces used to cover each section of the mattress.

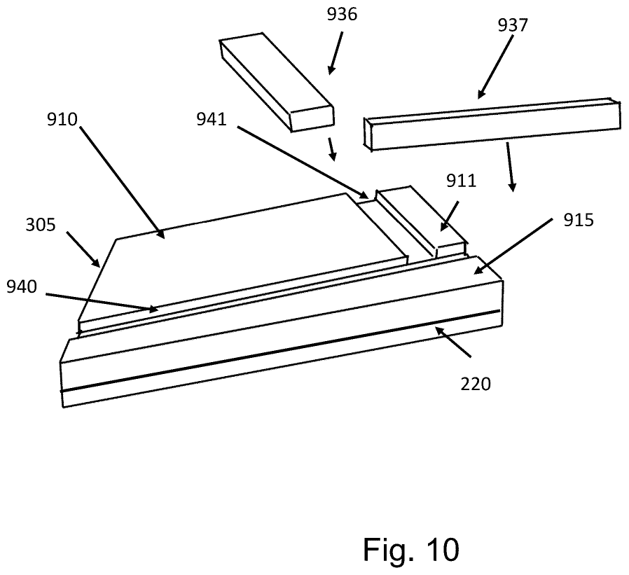

Referring to FIG. 10 which shows an alternative embodiment of the instant invention. The mattress of the instant invention has a first channel that runs parallel to the length of the mattress and a second channel that runs perpendicular to the first channel. The location of the channels can vary to achieve the requirements of the user to provide relief to a specific body part. In this embodiment the mattress has channel filler 936 which is removably installed so that the channel 941 can be filled and a person who sleeps on their back can comfortably use the mattress without the channel 941 being exposed. A person who needs to minimize pressure on a body part that aligns with the channel would remove channel filler 936 to expose channel 941. This embodiment also has channel filler 937 which is removably installed so that the channel 940 can be filled and a person who sleeps on their back can comfortably use the mattress without the channel 940 being exposed. A person who needs to minimize pressure on a body part that aligns with the channel 940 would remove channel filler 937 to expose channel 940.

The mattress 305 is formed from the following components the channel filler 936, channel filler 937, right mattress 915, left mattress 910, head mattress 911, and support 220. The space between right mattress 915 and left mattress 910 forms channel 940 which can removably receive channel filler 937. The space between left mattress 910 and head mattress 911 forms channel 941 which can removably receive channel filler 936. The right mattress 915, left mattress 910 and head mattress 911 can be attached to support 220 with attachment devices similar to 670, 671 and 672 shown in FIG. 6 and the attachment devices can be selected from Velcro, clips, adhesive, adhesive strips, straps or other attachment methods. The instant invention also anticipates a single fitted sheet or a multi piece bed sheet system where the multi piece bed sheet system has separate pieces used to cover each section of the mattress.

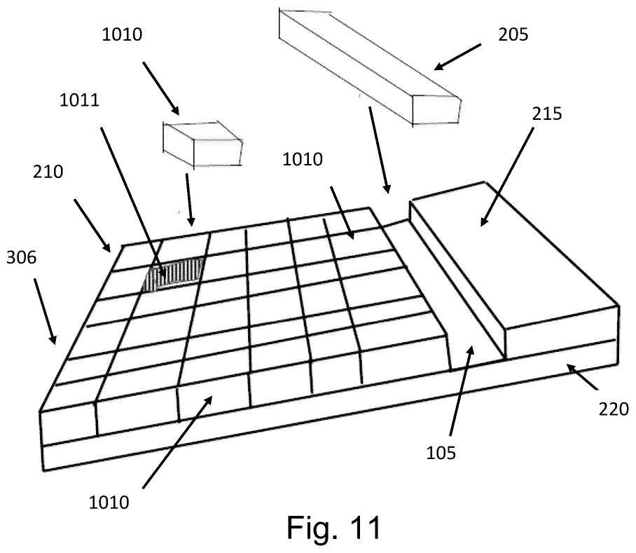

Referring to FIG. 11 which shows an alternative embodiment of the mattress of the instant invention where the mattress 306 is formed from head support member 215, lower mattress 210 which is formed from multiple mattress pieces 1010 and support 220. The space between head support member 215 and lower mattress 210 forms channel 105 which can removably accept channel filler 205.

Any person who needs to minimize pressure on a body part that aligns with the channel would remove channel filler 205 to expose the channel 105. This embodiment also has mattress pieces 1010 which are removably installed so that the holes 1011 can be filled. However mattress pieces 1010 can be removed to provide pressure relief to a person who needs to minimize pressure on a body part that aligns with a specific hole 1011; they would remove the corresponding mattress pieces 1010 to expose the hole 1011. The head support member 215, lower mattress 210, formed from multiple mattress pieces 1010, can be attached to support 220 with attachment devices similar to 670, 671 and 672 shown in FIG. 6 and the attachment devices can be selected from Velcro, clips, adhesive, adhesive strips, straps or other attachment methods. The instant invention also anticipates a single fitted sheet or a multi piece bed sheet system where the multi piece bed sheet system has separate pieces used to cover each section of the mattress.

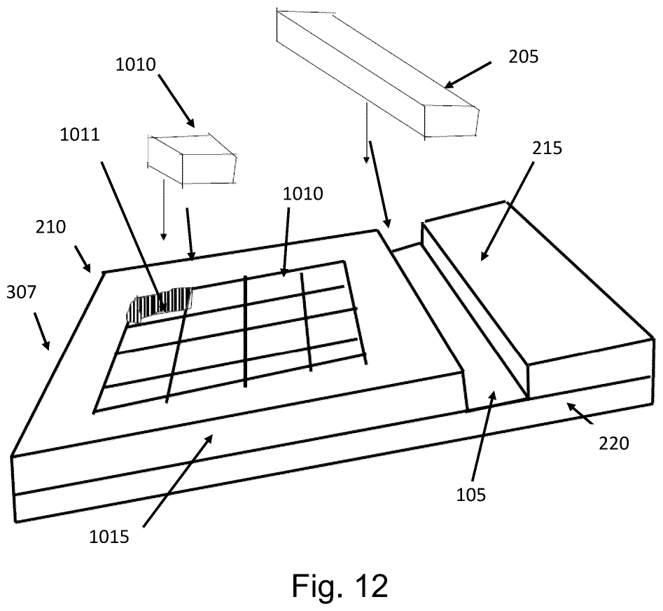

Referring to FIG. 12 which shows an alternative embodiment of the mattress of the instant invention where the mattress 307 is formed from head support member 215, support 220, lower mattress 210 which is formed from multiple mattress pieces 1010 and outer support 1015. The outer support 1015 forms a pocket to contain the multiple mattress pieces 1010. The space between head support member 215 and lower mattress 210 forms channel 105 which can removably accept channel filler 205.

A person who needs to minimize pressure on a body part that aligns with the channel would remove channel filler 205 to expose channel 105. This embodiment also has mattress pieces 1010 which are removably installed so that the hole 1011 can be filled. However mattress pieces 1010 can be removed to provide a person who needs to minimize pressure on a body part that aligns with the hole 1011 would remove mattress pieces 1010 to expose hole 1011. The head support member 215, lower mattress 210 which is formed from multiple mattress pieces 1010 and outer support 1015 can be attached to support 220 with attachment devices similar to 670, 671 and 672 shown in FIG. 6 and the attachment devices can be selected from Velcro, clips, adhesive, adhesive strips, straps or other attachment methods. The instant invention also anticipates a multi piece bed sheet system where the multi piece bed sheet system has separate pieces used to cover each section of the mattress.

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A mattress formed from mattress components which creates a sleeping surface having at least one channel and said at least one channel having at least one channel filler and said at least one channel in said mattress is configured to accommodate a person's body part comprising:
a. a lower mattress forming a lower mattress sleeping surface;
b. a head support member forming a head piece sleeping surface;
c. a mattress support enabled to support said lower mattress, said head support member and said at least one channel filler; and
d. said at least one channel filler is trapezoidal on cross section and said at least one channel is trapezoidal in cross section to receive said at least one channel filler.

2. The mattress of claim 1 wherein said mattress support is formed from an upper mattress support and a lower mattress support.

3. The mattress of claim 1 wherein said mattress support is attached to said lower mattress with an attachment device.

4. The mattress of claim 3 wherein said attachment device is selected from the group consisting of Velcro, clips, adhesive, adhesive strip and straps.

5. The mattress of claim 1 wherein said mattress support is attached to said head support member with an attachment device.

6. The mattress of claim 5 wherein said attachment device is selected from the group consisting of Velcro, clips, adhesive, adhesive strip and straps.

7. A mattress formed from mattress components which creates a sleeping surface having at least one channel in said mattress to accommodate a person's body part comprising:
a. a lower mattress forming a lower mattress sleeping surface;
b. a head support member forming a head piece sleeping surface;
c. at least one channel filler is trapezoidal in cross section and removably enabled to form a channel when said channel filler is removed from said mattress and when said channel filler is installed in said channel it forms part of said sleeping surface;
d. a mattress support enabled to support said lower mattress, said head support member and said at least one channel filler.

8. The mattress of claim 7 wherein said lower mattress sleeping surface has at least one lower mattress segment which forms a lower mattress sleeping surface and said at least one lower mattress segment being removably enabled to form at least one cavity.

9. The mattress of claim 7 wherein said mattress support is formed from an upper mattress support and a lower mattress support.

10. The mattress of claim 7 wherein said mattress support is attached to said lower mattress with an attachment device.

11. The mattress of claim 10 wherein said attachment device is selected from the group consisting of Velcro, clips, adhesive, adhesive strip and straps.

12. The mattress of claim 7 wherein said mattress support is attached to said head support member with an attachment device.

13. The mattress of claim 12 wherein said attachment device is selected from the group consisting of Velcro, clips, adhesive, adhesive strip and straps.

14. The mattress of claim 8 wherein said lower mattress sleeping surface has at least one lower mattress segment and an outer support which forms a lower mattress sleeping surface and said at least one lower mattress segment being removably enabled to form at least one cavity in said lower mattress sleeping surface and said outer support holds said at least one lower mattress segment within said outer support.

15. A mattress formed from mattress components which creates a sleeping surface and said sleeping surface having at least one cavity in said mattress to accommodate a person's body part comprising:
a. a lower mattress forming a lower mattress sleeping surface comprising of at least one lower mattress segment that is removably enabled to fit within an outer support;
b. said at least one lower mattress segment when removed from said outer support forms a lower mattress segment cavity in said lower mattress sleeping surface and said lower mattress segment cavity is capable of receiving a body part of a person;
c. a head support member forming a head piece sleeping surface;
d. at least one channel filler removably enabled to be received in a channel and said at least one channel filler forms a sleeping surface when installed in said channel;
e. a mattress support enabled to support said lower mattress, said head support member and said at least one channel filler; and
d. said at least one channel filler is trapezoidal on cross section and said at least one channel is trapezoidal in cross section to receive said at least one channel filler.

16. The mattress of claim 15 wherein said mattress support is formed from an upper mattress support and a lower mattress support.

17. The mattress of claim 15 wherein said mattress support is attached to said at least one lower mattress segment with an attachment device.

18. The mattress of claim 17 wherein said attachment device is selected from the group consisting of Velcro, clips, adhesive, adhesive strip and straps.

19. The mattress of claim 15 wherein said mattress support is attached to said head support member with an attachment device.

20. The mattress of claim 19 wherein said attachment device is selected from the group consisting of Velcro, clips, adhesive, adhesive strip and straps.
